(19) United States
(12) Patent Application Publication
(10) Pub. No.: US 2008/0082756 A1
(43) Pub. Date: Apr. 3, 2008

(54) Mechanisms and methods of using self-reconciled data to reduce cache coherence overhead in multiprocessor systems

(76) Inventor: Xiaowei Shen, Hopewell Junction, NY (US)

Correspondence Address: F. CHAU & ASSOCIATES, LLC, 130 WOODBURY ROAD, WOODBURY, NY, 11797, US

(21) Appl. No.: 11/541,911

(22) Filed: Oct. 2, 2006

(51) Int. Cl. G06F 13/28

(52) U.S. Cl. 711/141

(57) ABSTRACT

A system for maintaining cache coherence includes a plurality of caches, wherein at least a first cache and a second cache of the plurality of caches are connected via an interconnect network, a memory for storing data of a memory address, the memory connected to the interconnect network, and a plurality of coherence engines including a self-reconciled data prediction mechanism, wherein a first coherence engine of the plurality of coherence engines is operatively associated with the first cache, and a second coherence engine of the plurality of coherence engines is operatively associated with the second cache, wherein the first cache requests the data of the memory address in case of a cache miss, and receives one of a regular data copy or a self-reconciled data copy according to the self-reconciled data prediction mechanism.

### BACKGROUND OF THE INVENTION

1. Field of the Invention

The present invention relates to the field of computer systems, and more particularly, to using self-reconciled data to reduce cache coherence overhead in shared-memory multiprocessor systems.

2. Description of Related Art

A shared-memory multiprocessor system typically employs a cache coherence mechanism to ensure cache coherence. When a cache miss occurs, the requesting cache may send a cache request to the memory and all its peer caches. When a peer cache receives the cache request, the peer cache checks its cache directory and produces a cache snoop response indicating whether the requested data is found and the state of the corresponding-cache line. If the requested data is found in a peer cache, the peer cache can supply the data to the requesting cache via a cache-to-cache transfer. The memory is responsible for supplying the data if the data cannot be supplied by any peer cache.

Referring now to FIG. 1, an exemplary shared-memory multiprocessor system (100) is shown that includes multiple nodes interconnected via an interconnect network (102). Each node includes a processor core and a cache (for example, node 101 includes a processor core 103 and a cache 104). Also connected to the interconnect network are a memory (105) and I/O devices (106). The memory (105) can be physically distributed into multiple memory portions, such that each memory portion is operatively associated with a node. The interconnect network (102) serves at least two purposes: sending cache coherence requests to the caches and the memory, and transferring data among the caches and the memory. Although four nodes are depicted, it is understood that any number of nodes can be included in the system. Furthermore, it is to be understood that each processing unit may comprise a cache hierarchy with multiple caches, as contemplated by those skilled in the art.

There are many techniques for achieving cache coherence that are known to those skilled in the art. A number of so-called snoopy cache coherence protocols have been proposed. The MESI snoopy cache coherence protocol and its variations have been widely used in shared-memory multiprocessor systems. As the name suggests, MESI has four cache states: modified (M), exclusive (E), shared (S) and invalid (I). If a cache line is in an invalid state, the data in the cache is not valid. If a cache line is in a shared state, the data in the cache is valid and can also be valid in other caches. The shared state is entered when the data is retrieved from memory or another cache, and the corresponding snoop responses indicate that the data is valid in at least one of the other caches. If a cache line is in an exclusive state, the data in the cache is valid, and cannot be valid in another cache. Furthermore, the data in the cache has not been modified with respect to the data maintained at memory. The exclusive state is entered when the data is retrieved from memory or another cache, and the corresponding snoop responses indicate that the data is not valid in another cache. If a cache line is in a modified state, the data in the cache is valid and cannot be valid in another cache. Furthermore, the data has been modified as a result of a store operation.

When a cache miss occurs, if the requested data is found in both memory and another cache, supplying the data via a cache-to-cache transfer may be preferred because cache-to-cache transfer latency can be smaller than memory access latency. The IBM® Power 4 system, for example, enhances the MESI protocol to allow data of a shared cache line to be supplied to another cache in the same multi-chip module via a cache-to-cache transfer. In addition, if data of a modified cache line is supplied to another cache, the modified data is not written back to the memory immediately. A cache with the most up-to-date data can be held responsible for memory update when the data is eventually replaced.

A cache miss can be a read miss or a write miss. A read miss occurs when a shared data copy is requested on an invalid cache line. A write miss occurs when an exclusive data copy is requested on an invalid or shared cache line.

For the purposes of the present disclosure, a cache that generates a cache request is referred to as the “requesting cache” of the cache request. A cache request can be sent to one or more caches and the memory. Given a cache request, a cache is referred to as a “sourcing cache” if the corresponding cache state shows that the cache can supply the requested data to the requesting cache via a cache-to-cache transfer.

With typical snoopy cache coherence, a cache request is broadcast to all caches in the system. This can negatively affect overall performance, system scalability and power consumption, especially for large shared-memory multiprocessor systems. Further, broadcasting cache requests indiscriminately may consume large amounts of network bandwidth, while snooping peer caches indiscriminately may need excessive cache snoop ports. It is worth noting that servicing a cache request may take large amounts of time when far away caches are snooped unnecessarily.

Directory-based cache coherence protocols have been proposed to overcome the scalability limitation of snoop-based cache coherence protocols. Typical directory-based protocols maintain directory information as a directory entry for each memory block to record the caches in which the memory block is currently cached. With a full-map directory structure, for example, each directory entry comprises one bit for each node in the system, indicating whether the node has a data copy of the memory block. A dirty bit can be used to indicate if the data has been modified in a node without updating the memory to reflect the modified cache. Given a memory address, its directory entry is typically maintained in a node in which the corresponding physical memory resides. This node is referred to as the “home” of the memory address. When a cache miss occurs, the requesting cache sends a cache request to the home, which generates appropriate point-to-point coherence messages according to the directory information.

Reducing cache coherence overhead leads to improved scalability and performance of large-scale shared-memory multiprocessor systems. A hierarchical shared-memory multiprocessor system can employ snoopy and directory-based cache coherence at different cache levels. Regardless of whether snoopy or directory-based cache coherence is employed, when a processor intends to write to an address that is cached in a shared state, an invalidate request message typically needs to be sent to the caches in which the data is cached.

With a snoopy cache coherence protocol, a requesting cache broadcasts an invalidate request to all the caches. A snoopy cache coherence protocol can be further enhanced with a snoop filtering mechanism so that a requesting cache only needs to multicast an invalidate request to those caches in which the data may be cached according to the snoop filtering mechanism. When a cache receives an invalidate request, it invalidates the shared cache line, if any, and sends an invalidate acknowledgment back to the requesting cache. The invalidate acknowledgment can be a bus signal in a bus-based system, or a point-to-point message in a network-based system. The requesting cache cannot obtain the exclusive ownership of the corresponding cache line until all the invalidate acknowledgments are received.

With a directory-based cache coherence protocol, a requesting cache sends an invalidate request to the corresponding home, and the home multicasts an invalidate request to only the caches that the directory shows may contain the data. When a cache receives an invalidate request, it invalidates the shared cache line, if any, and sends an invalidate acknowledgment back to the home. When the home receives all the invalidate acknowledgments, the home sends a message to supply the exclusive ownership of the corresponding cache line to the requesting cache.

A shared-memory multiprocessor system implements a memory consistency model that defines semantics of memory access operations. Exemplary memory models include sequential consistency and various relaxed memory models such as release consistency. A system is sequentially consistent if the result of any execution is the same as if the operations of all the processors were executed in some sequential order, and the operations of each individual processor appear in this sequence in the order specified by its program.

For a memory write operation to an address that is cached in a shared state, sequential consistency typically requires that all the invalidate acknowledgments be received before any subsequent memory operation can be performed. A relaxed memory model, in contrast, may allow a subsequent memory operation to be performed, provided that all the invalidate operations are acknowledged before the next synchronization point. For example, release consistency classifies synchronizations as acquire and release operations. Before an ordinary load or store access can be performed with respect to another processors, all previous acquire accesses must be performed. Before a release access can be performed with respect to another processor, all previous ordinary load and store accesses must be performed.

It is obvious that invalidate requests and acknowledgments consume network bandwidth. Meanwhile, invalidate operations may also result in extra latency overhead. In a large-scale shared-memory system, the latency of an invalidate operation can vary dramatically. FIG. 2 illustrates an exemplary hierarchical shared-memory multiprocessor system that comprises multiple multi-chip modules. Each multi-chip module comprises multiple chips, wherein each chip comprises multiple processing nodes. As can be seen, nodes A, B, C and D are on the same chip (201), which is on the same multi-chip module (202) with nodes E and F. Node G is on another multi-chip module.

Consider an address that is currently cached in nodes A, B, C, D, E, F and G. Suppose the processor at node A intends to write to the address, therefore sending an invalidate request to nodes B, C, D, E, F and G. One skilled in the art will recognize that on-chip communication is typically faster than chip-to-chip communication, which is typically faster than module-to-module communication. As a result, the invalidate latency for nodes B, C and D is typically smaller than the invalidate latency for nodes E and F, which is typically smaller than the invalidate latency for node G. In this case, it would be inefficient for node A to wait for an invalidate acknowledgment from node G.

Therefore, a need exists for a mechanism to reduce cache coherence overhead in multiprocessor systems.

### SUMMARY OF THE INVENTION

According to an embodiment of the present disclosure, a system for maintaining cache coherence comprises a plurality of caches, wherein at least a first cache and a second cache of the plurality of caches are connected via an interconnect network, a memory for storing data of a memory address, the memory connected to the interconnect network, and a plurality of coherence engines comprising a self-reconciled data prediction mechanism, wherein a first coherence engine of the plurality of coherence engines is operatively associated with the first cache, and a second coherence engine of the plurality of coherence engines is operatively associated with the second cache, wherein the first cache requests the data of the memory address in case of a cache miss, and receives one of a regular data copy or a self-reconciled data copy according to the self-reconciled data prediction mechanism.

According to an embodiment of the present disclosure, a computer-implemented method for maintaining cache coherence, comprises requesting a data copy by a first cache to service a cache miss on a memory address, generating a self-reconciled data prediction result by a self-reconciled data prediction mechanism, the prediction result indicating whether a regular data copy or a self-reconciled data copy is to be supplied, and receiving one of the regular data copy and the self-reconciled data copy by the first cache according to the self-reconciled data prediction result.

According to an embodiment of the present disclosure, a program storage device is provided readable by machine, tangibly embodying a program of instructions executable by the machine to perform method steps for maintaining cache coherence. The method includes requesting a data copy by a first cache to service a cache miss on a memory address, generating a self-reconciled data prediction result by a processor executing a self-reconciled data prediction mechanism, the prediction result indicating whether a regular data copy or a self-reconciled data copy is to be supplied, and receiving one of the regular data copy and the self-reconciled data copy by the first cache according to the self-reconciled data prediction result.

### BRIEF DESCRIPTION OF THE DRAWINGS

The invention may be understood by reference to the following description taken in conjunction with the accompanying drawings, in which like reference numerals identify like elements, and in which:

FIG. 1 depicts an exemplary shared-memory multiprocessor system that includes multiple nodes interconnected via an interconnect network, wherein each node includes a processor core and a cache;

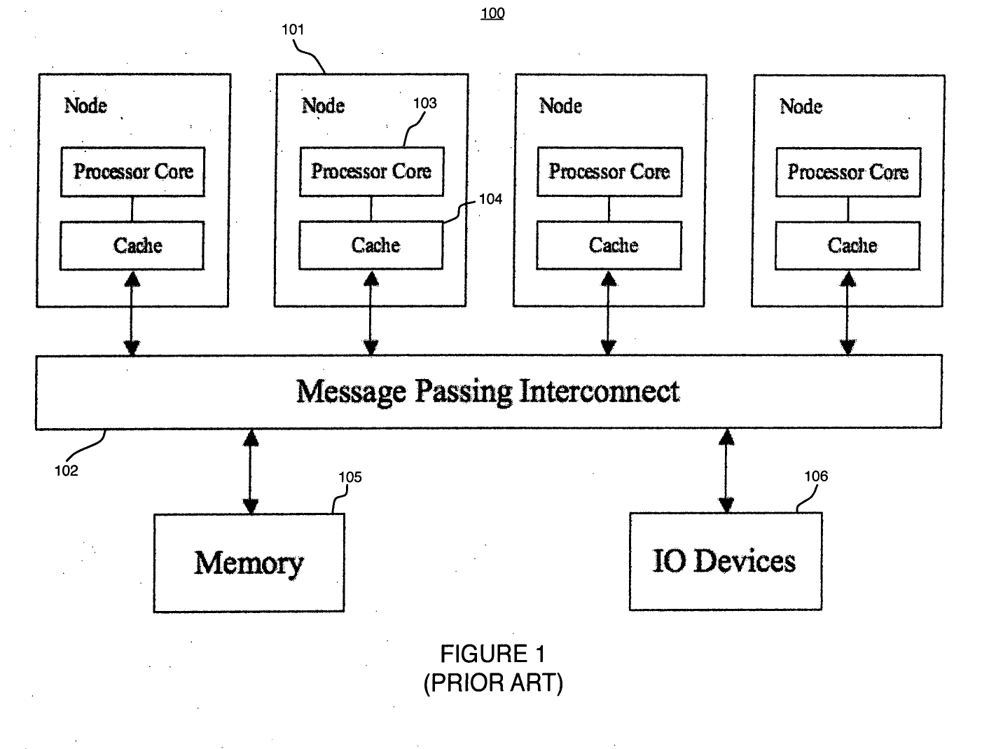

FIG. 2 depicts an exemplary hierarchical shared-memory multiprocessor system that comprises multiple multi-chip modules, wherein each multi-chip module comprises multiple chips;

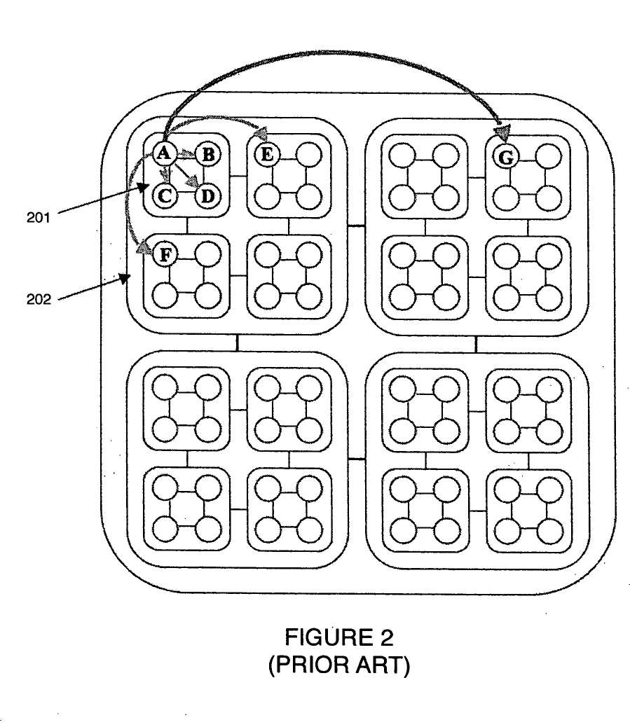

FIG. 3 depicts a shared-memory multiprocessor system that includes multiple nodes interconnected via an interconnect network, wherein each node includes a coherence engine that supports self-reconciled data prediction;

FIG. 4 illustrates an exemplary self-reconciled data prediction process in a multiprocessor system with snoopy cache coherence according to an embodiment of the present disclosure;

FIG. 5 illustrates an exemplary self-reconciled data prediction process in a multiprocessor system with directory-based cache coherence according to an embodiment of the present disclosure;

FIG. 6 shows a cache state transition diagram that involves a regular shared state, a shared-transient state and a shared-transient-speculative state, according to an embodiment of the present disclosure; and

FIG. 7 is a diagram of a system according to an embodiment of the present disclosure.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the disclosure.

According to an embodiment of the present disclosure, self-reconciled data is used to reduce cache coherence overhead in multiprocessor systems. A cache line is self-reconciled if the cache itself is responsible for maintaining the coherence of the data, where in case the data is modified in another cache, cache coherence cannot be compromised without an invalidate request being sent to invalidate the self-reconciled cache line.

When a cache needs to obtain a shared copy, the cache can obtain either a regular copy or a self-reconciled copy. The difference between a regular copy and a self-reconciled copy is that, if the data is later modified in another cache, that cache needs to send an invalidate request to invalidate the regular copy, but does not need to send an invalidate request to invalidate the self-reconciled copy. Software, executed by a processor, can provide heuristic information indicating whether a regular copy or a self-reconciled copy should be used. For example, such heuristic information can be associated with a memory load instruction, indicating whether a regular copy or a self-reconciled copy should be retrieved if a cache miss is caused by the memory load operation.

Alternatively, the underlying cache coherence protocol of a multiprocessor system can be enhanced with a self-reconciled data prediction mechanism, wherein the self-reconciled data prediction mechanism determines, when a requesting cache needs to retrieve data of an address, whether a regular copy or a self-reconciled copy should be supplied to the requesting cache. With snoopy cache coherence, the self-reconciled data prediction can be implemented at the requesting cache side or at the sourcing cache side; with directory-based cache coherence, the self-reconciled data prediction can be implemented at the requesting cache side or at the home side.

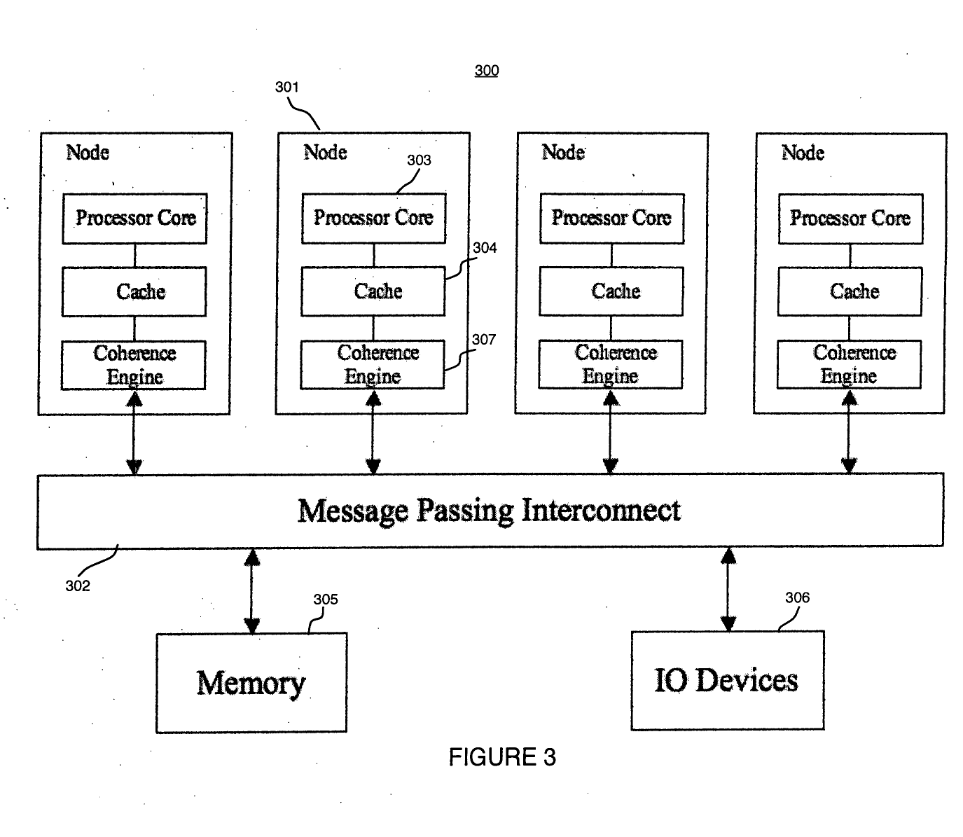

Referring now to FIG. 3, a shared-memory multiprocessor system (300) is shown that includes multiple nodes interconnected via an interconnect network (302). Each node includes a processor core, a cache and a coherence engine (for example, node 301 includes a processor core 303, a cache 304 and a coherence engine 307). Also connected to the interconnect network are a memory (305) and I/O devices (306). Each coherence engine is operatively associated with the corresponding cache, and implements a cache coherence protocol that ensures cache coherence for the system. A coherence engine may be implemented as a component of the corresponding cache or a separate module from the cache. The coherence engines, either singularly or in cooperation with one another, provide implementation support for self-reconciled data prediction.

In a multiprocessor system that uses a snoopy cache coherence protocol, self-reconciled data may be used if the snoopy protocol is augmented with proper filtering information so that an invalidate request does not always need to be broadcast to all the caches in the system.

An exemplary self-reconciled data prediction mechanism is implemented at the sourcing cache side. When a sourcing cache receives a cache request for a shared copy, the sourcing cache predicts that a self-reconciled copy should be supplied if (a) the snoop filtering information shows that no regular data copy is cached in the requesting cache (so that if a self-reconciled copy is supplied, an invalidate operation can be avoided in the future according to the snoop filtering information), and (b) a network traffic monitor indicates that network bandwidth consumption is high due to cache coherence messages.

Another exemplary self-reconciled data prediction is implemented via proper support at both the requesting cache side and the sourcing cache side. In case of a read cache miss, the requesting cache predicts that a self-reconciled copy should be provided if the corresponding address is not found in the requesting cache. The requesting cache predicts that a regular copy should be provided if the corresponding address is found in an invalid state in the requesting cache. The requesting cache side prediction result is attached to the corresponding cache request issued from the requesting cache. When a sourcing cache receives the cache request, the sourcing cache predicts that a self-reconciled copy should be provided if the snoop filtering information shows that (a) no regular data copy is cached in the requesting cache, and (b) the requesting cache is far away from other caches in which a regular data copy may be cached at the time. The sourcing cache supplies a self-reconciled copy if both the requesting cache side prediction result and the sourcing cache side prediction result indicate that a self-reconciled copy should be supplied. It should be noted that, if no sourcing cache exists, the memory can supply a regular copy to the requesting cache.

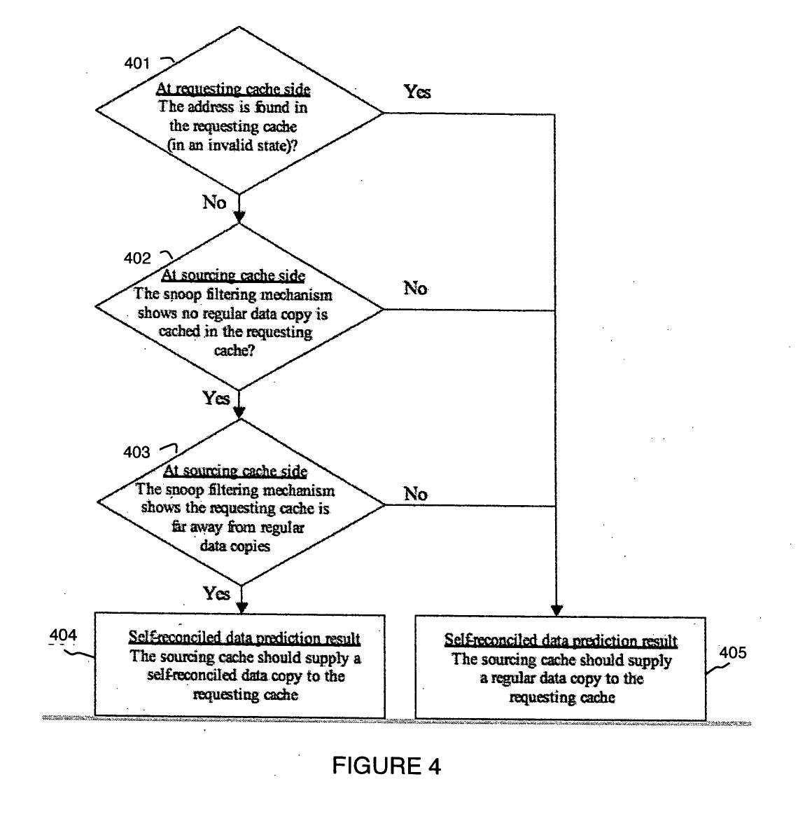

FIG. 4 illustrates the self-reconciled data prediction process described above, in the case that requested data is supplied from a sourcing cache. If the requested address is not found in the requesting cache (401), the snoop filtering mechanism at the sourcing cache side shows that no regular data copy of the requested address is cached in the requesting cache (402), and the snoop filtering mechanism at the sourcing cache side also shows that the requesting cache is far away from regular data copies of the requested address (403), the overall self-reconciled data prediction result is that the sourcing cache should supply a self-reconciled copy to the requesting cache (404). Otherwise, the overall self-reconciled data prediction result is that the sourcing cache should supply a regular data copy to the requesting cache (405).

In a multiprocessor system that uses a directory-based cache coherence protocol, the self-reconciled data prediction can be implemented at the requesting cache side or at the home side. An exemplary self-reconciled data prediction mechanism is implemented at the home side. When the home of an address receives a read cache request, the home determines that a self-reconciled copy should be supplied if the communication latency between the home and the requesting cache is significantly larger than that between the home and other caches in which a regular data copy may be cached at the time according to the corresponding directory information.

Another exemplary self-reconciled data prediction mechanism is implemented via proper support at both the requesting cache side and at the home side. In case of a read cache miss, the requesting cache predicts that a self-reconciled copy should be provided if the corresponding address is not found in the requesting cache. The requesting cache predicts that a regular copy should be provided if the corresponding address is found in an invalid state in the requesting cache. The requesting cache side prediction result is included to the corresponding cache request sent from the requesting cache to the home. When the home receives the cache request, the home predicts that a self-reconciled copy should be supplied if the communication latency between the home and the requesting cache is significantly larger than that between the home and other caches in which a regular data copy may be cached according to the corresponding directory information. Finally, the home determines that a self-reconciled copy should be supplied if both the requesting cache side prediction result and the home side prediction result indicate that a self-reconciled copy should be supplied.

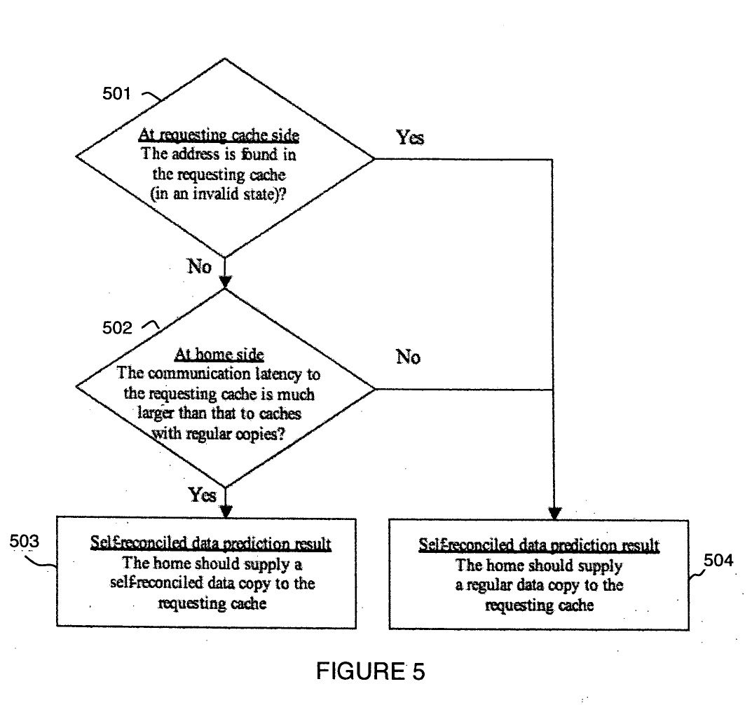

FIG. 5 illustrates the self-reconciled data prediction process described above. If the requested address is not found in the requesting cache (501), and the communication latency between the home and the requesting cache is larger than the communication latency between the home and peer caches in which the home directory shows a regular data copy may be cached at the time (502), the overall self-reconciled data prediction result is that the home should supply a self-reconciled copy to the requesting cache (503). Otherwise, the overall self-reconciled data prediction result is that the home should supply a regular data copy to the requesting cache (504).

A directory-based cache coherence protocol can choose to use limited directory space to reduce overhead of directory maintenance, wherein a limited number of cache identifiers can be recorded in a directory. An exemplary self-reconciled data prediction mechanism implemented at the home side determines that a self-reconciled copy should be supplied if the limited directory space has been used up and no further cache identifier can be recorded in the corresponding directory. Alternatively, the home can supply a regular data copy to the requesting cache, and downgrade a regular data copy cached in another cache to a self-reconciled data copy (so that the corresponding cache identifier no longer needs to be recorded in the directory).

In an illustrative embodiment of the present invention, a cache coherence protocol is extended with new cache states to allow self-reconciled data to be used. For a shared cache line, in addition to the regular shared (S) cache state, we introduce two new cache states, shared-transient (ST) and shared-transient-speculative (STS). If a cache line is in the regular shared state, the data is a regular shared copy. Consequently, if the data is modified in a cache, that cache needs to issue an invalidate request so that the regular shared copy can be invalidated in time.

If a cache line is in the shared-transient state, the data is a self-reconciled shared copy that would not be invalidated should the data is modified in another cache. It should be noted that the data of the cache line in the shared-transient state can be used for only once without performing a self-reconcile operation to ensure that the data is indeed up-to-date. The exact meaning that the data can be used for only once depends on the semantics of the memory model. With sequential consistency, the data is guaranteed to be up-to-date for one read operation; with a weak memory model, the data can be guaranteed to be up-to-date for read operations before the next synchronization point.

For a cache line in the shared-transient state, once data of the cache line is used, the cache state of the cache line becomes shared-transient-speculative. The shared-transient-speculative state indicates that the data of the cache line can be update-to-date or out-of-date. As a result, the cache itself, rather than its peer caches or the memory, is ultimately responsible for maintaining the data coherence. It should be noted that the data of the shared-transient-speculative cache line can be used as speculative data so that the corresponding processor accessing the data can continue its computation speculatively. Meanwhile, the corresponding cache needs to issue appropriate coherence messages to its peer caches and the memory to ensure that up-to-date data is obtained if the data is modified elsewhere. Computation using speculative data typically needs to be rolled back if the speculative data turns out to be incorrect.

It should be appreciated by those skilled in the art that, when data of an address is cached in multiple caches, the data can be cached in the regular shared state, the shared-transient state and the shared-transient-speculative state in different caches at the same time. Generally speaking, the data is cached in the shared-transient state in a cache if the cached data will be used only once or very few times before it is modified by another processor, or the invalidate latency of the shared copy is larger than that of other shared copies. The self-reconciled data prediction mechanisms described above can be used to predict whether requested data of a cache miss should be cached in a regular shared state or in a shared-transient state.

When data of a shared cache line needs to be modified, the cache only needs to send an invalidate request to those peer caches in which the data is cached in the regular shared state. If bandwidth allowed, the cache can also send an invalidate request to the peer caches in which the data is cached in the shared-transient state or the shared-transient-speculative state. This allows data cached in the shared-transient state or the shared-transient-speculative state to be invalidated quickly to avoid speculative use of out-of-date data. It should be noted that invalidate operations of shared-transient and shared-transient-speculative copies do not need to be acknowledged. It should also be noted that the proposed mechanism works even though invalidate requests to shared-transient or shared-transient-speculative caches are lost. The net effect is that some out-of-date data would be used in speculative executions (which would be rolled back eventually) since the cache lines are not invalidated in time.

For a cache line in the shared-transient-speculative state, the cache state can be augmented with a so-called access counter (A-counter), wherein the A-counter records the number that data of the cache line has been accessed since the data is cached. The A-counter can be used to determine whether a shared-transient-speculative cache line should be upgraded to a regular shared cache line. For example, the A-counter can be a 2-bit counter with a pre-defined limit of 3.

When a processor reads data from a shared-transient cache line, the cache state is changed to shared-transient-speculative (with a weak memory model, this state change can be postponed to the next proper synchronization point). The A-counter is set to 0.

When a processor reads data from a shared-transient-speculative cache line, it uses the data speculatively. The processor typically needs to maintain sufficient information so that the system state can be rolled back if the speculation turns out to be incorrect. The cache needs to perform a self-reconcile operation by sending a proper coherence message to check whether the speculative data is up-to-date, and retrieves the most update-to-date data if the speculative data maintained in the cache is out-of-date.

If the A-counter is below the pre-defined limit, the cache performs a self-reconcile operation by issuing a shared-transient read request. Meanwhile, the A-counter is incremented by 1. When the cache receives the data, the cache compares the received data with the shared-transient-speculative data. If there is a match, the computation continues, and the cache state remains as shared-transient-speculative (with a weak memory model, the cache state can be set to shared-transient until the next synchronization point). However, if there is a mismatch, the speculative computation is rolled back, and the received data is cached in the shared-transient-speculative state (with a weak memory model, the received data can be cached in the shared-transient state until the next synchronization point).

On the other hand, if the A-counter reaches the pre-defined limit, the cache performs a self-reconcile operation by issuing a shared read request. When the cache receives the data, the cache compares the received data with the shared-transient-speculative data. If there is a match, the cache state is changed to regular shared; otherwise the speculative execution is rolled back, and the received data is cached in the shared state.

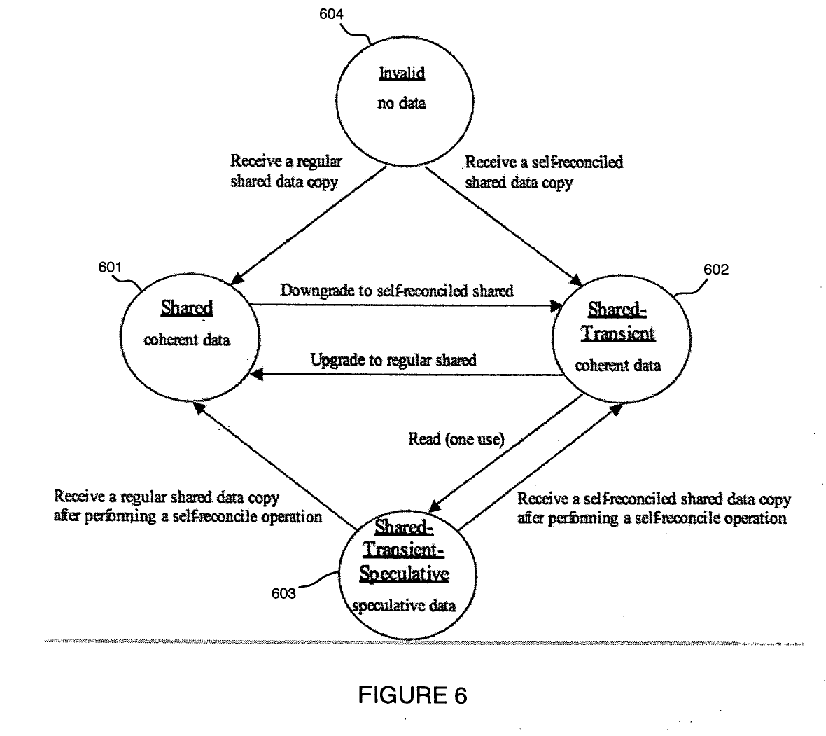

FIG. 6 shows a cache state transition diagram that describes cache state transitions among the shared (601), shared-transient (602) and shared-transient-speculative (603) states, according to an embodiment of the present disclosure. The cache line state may begin in an invalid state (604) containing no data for a given memory address. The invalid state can move to the shared state (601) or the shared-transient state (602), depending on whether a regular data copy or a self-reconciled data copy is received. Data in a shared or shared-transient cache line is guaranteed to be coherent, while data in a shared-transient-speculative cache line is speculatively coherent and may be out-of-date. A shared state (601) can move to a shared-transient state (602) by performing a downgrade operation that downgrades a regular shared copy to a self-reconciled copy. A shared-transient state (602) can move a shared state (601) by performing an upgrade operation that upgrades a self-reconciled copy to a regular shared copy. A shared-transient-speculative state (603) can move to a share state (601) after performing a self-reconcile operation to receive a regular shared copy. A shared-transient-speculative state (603) can move to a shared-transient state (602) after performing a self-reconcile cooperation to receive a self-reconciled copy. A shared-transient state (602) moves to a shared-transient-speculative state (603) once the data is used.

It is to be understood that the systems and methods described herein may be implemented in various forms of hardware, software, firmware, special purpose processors, or a combination thereof. It is to be understood that, because some of the constituent system components and process steps depicted in the accompanying figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present disclosure.

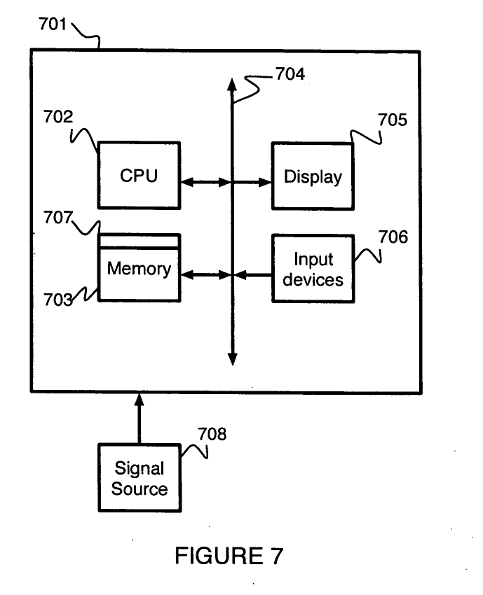

Referring to FIG. 7, according to an embodiment of the present disclosure, a computer system (701) for implementing a method for maintaining cache coherence can comprise, inter alia, a central processing unit (CPU) (702), a memory (703) and an input/output (I/O) interface (704). The computer system (701) is coupled through the I/O interface (604) to a display (705) and various input devices (706) such as a mouse and keyboard. The support circuits can include circuits such as cache, power supplies, clock circuits, and a communications bus. The memory (703) can include random access memory (RAM), read only memory (ROM), disk drive, tape drive, etc., or a combination thereof. A method for maintaining cache coherence can be implemented as a routine (707) that is stored in memory (703) and executed by the CPU (702) to process the signal from the signal source (708). As such, the computer system (601) is a general-purpose computer system that becomes a specific purpose computer system when executing the routine (707) of the present disclosure.

The computer platform (701) also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. A system for maintaining cache coherence comprising:
a plurality of caches, wherein at least a first cache and a second cache of the plurality of caches are connected via an interconnect network;
a memory for storing data of a memory address, the memory connected to the interconnect network; and
a plurality of coherence engines comprising a self-reconciled data prediction mechanism, wherein a first coherence engine of the plurality of coherence engines is operatively associated with the first cache, and a second coherence engine of the plurality of coherence engines is operatively associated with the second cache,
wherein the first cache requests the data of the memory address in case of a cache miss, and receives one of a regular data copy or a self-reconciled data copy according to the self-reconciled data prediction mechanism.

2. The system of claim 1, wherein the first cache receives the self-reconciled data copy and maintains cache coherence of the self-reconciled data copy, even without receiving an invalidate request in case the data of the memory address is modified in the second cache.

3. The system of claim 2, further comprising a plurality of processors, wherein computer-readable code executed by a first processor of the plurality of processors provides information determining, when the first cache requests the data of the memory address, whether the regular data copy or the self-reconciled data copy should be supplied for the memory address.

4. The system of claim 2, wherein the self-reconciled data prediction mechanism determines, when the first cache requests the data of the memory address, whether the regular data copy or the self-reconciled data copy should be supplied.

5. The system of claim 4, wherein the plurality of coherence engines implement snoopy-based cache coherence and comprise snoop filtering mechanisms.

6. The system of claim 4, wherein the plurality of coherence engines implement directory-based cache coherence.

7. The system of claim 4, wherein the self-reconciled data prediction mechanism determines that the regular data copy should be supplied if the memory address is found in the first cache in an invalid cache state, and the self-reconciled data copy should be supplied if the memory address is not found in the first cache.

8. The system of claim 2,
wherein the first cache includes a cache line with shared data of the memory address, and the cache line can be in one of a first cache state indicating that the cache line contains up-to-date data, a second cache state indicating that the cache line contains up-to-date data for limited uses, and a third cache state indicating that the cache line contains speculative data for speculative computation.

9. The system of claim 8,
wherein the first cache changes the cache line from the first cache state to the second cache state, upon the first cache performing a downgrade operation that downgrades the first cache state to the second cache state; and
wherein the first cache changes the cache line from the second cache state to first cache state, upon the first cache performing an upgrade operation that upgrades the second cache state to the first cache state.

10. The system of claim 8, wherein the first cache changes the cache line form the second cache state to the third cache state, upon the shared data in the first cache being accessed.

11. The system of claim 8,
wherein the first cache changes the cache line from the third cache state to the first cache state, upon the first cache performing a self-reconcile operation to receive a regular shared copy of the memory address; and
wherein the first cache changes the cache line from the third cache state to the second cache state, upon the first cache performing a self-reconcile operation to receive a self-reconciled shared copy of the memory address.

12. The system of claim 8, wherein the third cache state is augmented with an access counter, the access counter being used to determine, upon a self-reconcile operation needing to be performed, whether the cache line is to be upgraded to the first cache state or the second cache state.

13. A computer-implemented method for maintaining cache coherence, comprising:
requesting a data copy by a first cache to service a cache miss on a memory address;
generating a self-reconciled data prediction result by a self-reconciled data prediction mechanism, the prediction result indicating whether a regular data copy or a self-reconciled data copy is to be supplied; and
receiving one of the regular data copy and the self-reconciled data copy by the first cache according to the self-reconciled data prediction result.

14. The method of claim 13, further comprising:
receiving the self-reconciled data copy at the first cache; and
maintaining cache coherence, by the first cache, of the self-reconciled data copy, even without receiving an invalidate request in case the data of the memory address is modified in a second cache.

15. The method of claim 13, further comprising:
placing, by the first cache, the regular data copy in a cache line in a first cache state upon receiving the regular data copy at the first cache; and
placing, by the first cache, the self-reconciled copy in a cache line in a second cache state upon receiving the self-reconciled data copy at the first cache.

16. The method of claim 15, further comprising:
accessing the self-reconciled data copy in the first cache; and
changing the cache line from the second cache state to a third cache state, the third cache state indicating that the first cache includes speculative data for the memory address that can be used in speculative computation.

17. The method of claim 16, further comprising:
generating a self-reconcile request prediction result, indicating whether the cache line is to be upgraded to the first cache state, upgraded to a the second cache state, or kept in the third cache state;
sending a cache request, by the first cache, to request a regular data copy or a self-reconciled data copy, according to the self-reconcile request prediction result; and
receiving one of a regular data copy or a self-reconciled data copy by the first cache.

18. A program storage device readable by machine, tangibly embodying a program of instructions executable by the machine to perform method steps for maintaining cache coherence, the method steps comprising:
requesting a data copy by a first cache to service a cache miss on a memory address;
generating a self-reconciled data prediction result by a processor executing a self-reconciled data prediction mechanism, the prediction result indicating whether a regular data copy or a self-reconciled data copy is to be supplied; and
receiving one of the regular data copy and the self-reconciled data copy by the first cache according to the self-reconciled data prediction result.

19. The programmable storage device of claim 18, wherein the first cache receives the self-reconciled data copy and maintains cache coherence of the self-reconciled data copy, even without receiving an invalidate request in case the data of the memory address is modified in a second cache.
